(19) United States
(12) Patent Application Publication
(10) Pub. No.: US 2005/0280488 A1
(43) Pub. Date: Dec. 22, 2005

(54) Foldable portable magnetic tool mat

(76) Inventor: Rita M. Devine, Sarasota, FL (US)

Correspondence Address: GIFFORD, KRASS, GROH, SPRINKLE & CITKOWSKI, P.C, PO BOX 7021, TROY, MI, 48007-7021, US

(21) Appl. No.: 10/404,372

(22) Filed: Apr. 1, 2003

Related U.S. Application Data
(63) Continuation-in-part of application No. 10/101,085, filed on Mar. 19, 2002, now Pat. No. 6,587,022.

(51) Int. Cl. H01F 7/02

(52) U.S. Cl. 335/306

(57) ABSTRACT

A foldable, portable, magnetic tool mat. The tool mat includes generally rectangular obverse and reverse panels each formed of flexible material and connected together along substantially common side and end margins defining elongated magnet bar holding portions. A magnet is held within each holding portion each without substantially inhibiting selective tool mat folding for fit and storage. The reverse panel is substantially thicker than the obverse panel for better wear characteristics and maximal magnetic attractive forces for tool and hardware retention. An attaching strap can be used to hold the tool mat.

### CROSS-REFERENCE TO RELATED APPLICATIONS

This application is a continuation-in-part of patent application Ser. No. 10/101,085 filed Mar. 19, 2002, now U.S. Pat. No. ______, which is hereby incorporated by reference in its entirety.

### BACKGROUND OF THE INVENTION

1. Field of the Invention

This invention relates generally to portable magnetic tool holders, and more particularly to a flexible, collapsible mat particularly sized for use atop a collapsible ladder, around the leg of a user or for attachment to a tool box.

2. Reference to Related Art

More and more people are venturing into the home improvement area, both on a homeowner basis and professionally. Many of the tools, accessories and work items are made of magnetically attractable material. The more readily accessible these tools are made of magnetically attractable material. The more readily accessible these tools and other magnetically attractable items are to the user, the greater the likelihood of project success and shortened the time for project completion.

A number of prior art devices provide a magnetic attraction means for magnetically retaining work items in a stored or in a readily accessible position. One such device is disclosed in U.S. Pat. No. 6,267,277 invented by Taylor which discloses a portable, flexible tool holder having a plurality of pockets and loops therein for holding tools or, in lieu thereof, magnets associated with each pocket for the same purpose of holding tools in place within the pocket.

Another magnetic tool holder invented by Bosch is disclosed in U.S. Pat. No. 4,826,059 teaching a magnetic tool holder, preferably in the form of an apron, which includes a set of magnetic bars positioned side by side so as to provide magnetic attraction on both sides thereof. The length of the magnetic bars, being less than half the width of the device, is such that the tool holder may be easily folded along specific center fold lines for storage.

A protective fender cloth provides magnetic flexible strips as disclosed in U.S. Pat. No. 3,924,212 invented by Brown having the magnetic strips positioned on alternate sides of the device to render the cloth non-slipable when placed atop a magnetically attractable fender of a vehicle.

Other magnetic material-based devices are disclosed in U.S. Pat. No. 3,665,355 invented by Sasaki, Sherman's invention directed to a fisherman's hatband as disclosed in U.S. Pat. No. 2,597,601, a magnetic tool and object holder invented by Testa as disclosed in U.S. Pat. No. 5,760,668 and in U.S. Pat. No. 6,336,555, Breeden discloses a magnetic school organizer.

The present invention provides a portable and easily deployable and collapsible magnetic tool mat which is particularly sized to fit atop and be secured to a top ladder or platform of a collapsible ladder. An auxiliary strap is also provided to, in effect, lengthen the device so that it may be retained around the thigh of a user for retention of magnetically attractable articles.

### SUMMARY OF THE INVENTION

This invention is directed to a foldable, portable, magnetic tool mat. The tool mat includes generally rectangular obverse and reverse panels each formed of flexible material and connected together along substantially common side and end margins and along evenly apart seam lines extending along substantially the length of the device between said side margins defining magnet holding portions. A magnet bar is held within each magnetic holding portion without substantially inhibiting selective tool mat deployment and folding for storage. The reverse panel is substantially thicker than the obverse panel for better wear characteristics and maximal magnetic attractive forces for tool and hardware retention. The tool mat of the present invention is easily portable and deployable, both aspects being facilitated by the positioning and orientation of the elongated closely spaced magnetic bars held therein.

An attaching strap holds the tool mat to a support surface. Alternatively, the tool mat may use magnets to affix the tool mat to an object, such as a tool box, or may have grommets for use in suspending or hanging the tool mat. The tool mat may also be secured around the thigh of the user to hold magnetically attractable tool and accessories and items in readily accessible reach by a wearer of the device.

### BRIEF DESCRIPTION OF THE DRAWINGS

A better understanding of the present invention will be had upon reference to the attached drawings, wherein like reference numerals refer to like parts throughout, and wherein”

FIG. 1 is a broken plan view of a preferred embodiment of the invention;

FIG. 2 is a right and elevation view of FIG. 1;

FIG. 3 is a simplified perspective view of the invention showing an optional auxiliary strap;

FIG. 4 is a longitudinal section view through a portion of FIG. 1;

FIG. 5 is a perspective view of the invention in use atop a collapsible step ladder;

FIG. 6 is an enlarged view of the upper portion of the step ladder of FIG. 5;

FIG. 7 is a perspective view of the invention in use attached to a thigh or upper leg of a user;

FIG. 8 is a perspective view of the invention in the collapsed configuration for storage;

FIGS. 9A-B are broken plan views of a first alternative embodiment of the invention;

FIG. 9C is a perspective view of a magnetic bar of the first alternative embodiment;

FIGS. 10A-B are broken plan views of a second alternative embodiment of the invention;

FIG. 11 is a broken plan view of a third alternative embodiment of the invention; and

FIGS. 12A-B are a broken plan view of a fourth alternative embodiment of the invention.

### DETAILED DESCRIPTION

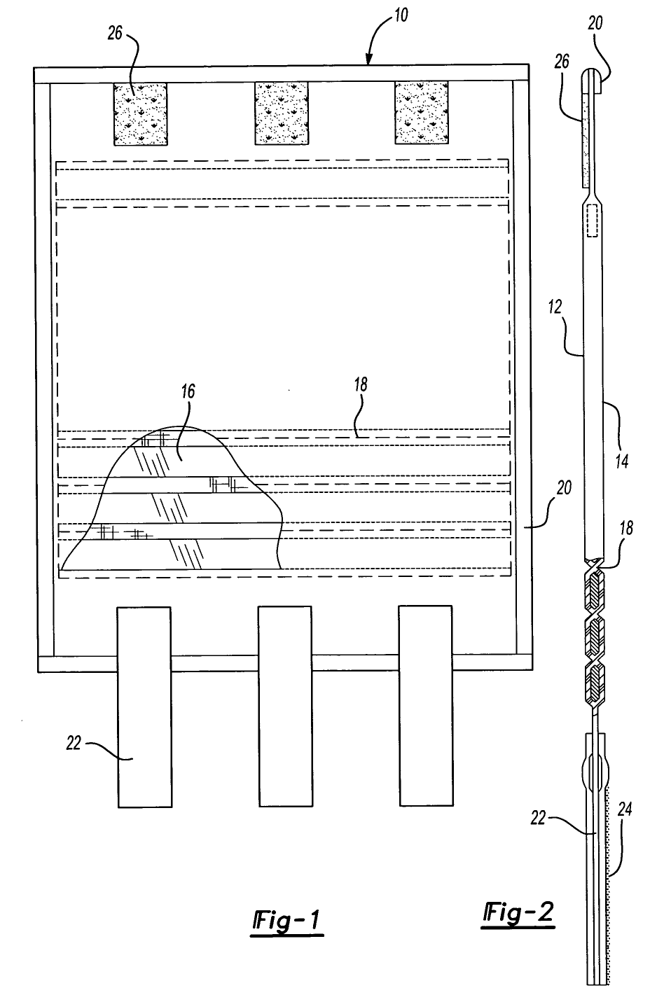

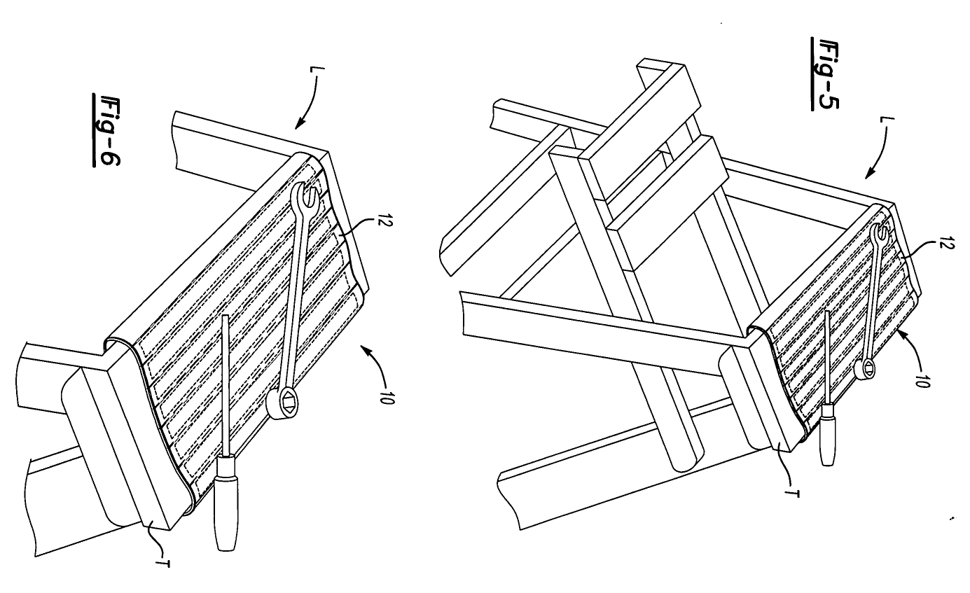

Referring now to FIGS. 1-8, a tool mat 10 has a generally rectangular plan configuration and, as best seen in FIGS. 2 and 4, is constructed of an obverse panel 12 and a reverse panel 14 that are connected along common side and end margins and then finished in appearance by sewing binding material 20 along substantially all of the side and edge margins.

The obverse panel 12 is formed of relatively thinner flexible elastic fabric material, preferably about 210 denier nylon material. PVC sponge material of comparable thickness and elasticity is an alternative. The reverse panel 14 is formed of substantially heavier flexible material, preferably 2000 denier nylon or Ballistic Cordura. In addition to the panels 12 and 14 being connected together along their common side and end margins, they are also connected together along seam lines 18 in FIGS. 1 and 2 and 18a and 18b shown in FIG. 4. The seam lines 18, 18a and 18b are spaced apart in generally parallel fashion one to another and parallel to the end margins so as to define a plurality of closely spaced side by side elongated magnetic bar holding portions 19 (or pockets) that are sized to snugly receive an elongated magnetic bar 16 positioned and secured therein as best seen in FIGS. 1,2 and 4. The magnetic bars 16 are formed of highly magnetic material such as sintered ferrite C8 or anisotropic boded ferrite for added toughness and are well known in the industry for high magnetic strength. Alternatively, as will be described below, the magnetic bars may be a ceramic or rare earth magnetic material. The ends and/or edges of the magnetic bars 16 are preferably rounded to inhibit the bars 16 from piercing either of the panels 12, 14 during use.

As previously described, the obverse panel 12 is formed of relatively thin fabric material so as to minimize the loss of magnetic attraction by minimizing the space between a tool placed against the obverse panel 12 and each magnet 16 itself. The reverse surface 14, being formed of heavier flexible fabric material, is positionable against a work surface or a substrate that may be irregular, soiled and otherwise contaminated and, therefore, a heightened wear resistivity is provided through the preferred use of the heavier, more durable obverse panel material.

Referring additionally to FIGS. 5 and 6, the preferred embodiment of the tool mat 10 is sized in length and width to substantially cover a top step T of a conventional stepladder L. The top step T is typically utilized to support tools and other accessories and work implements such as there shown in FIGS. 5 and 6 and additionally nails, screws, brads, marking implements and the like. Virtually all of these items are typically formed of magnetically attractable material. By dimensionally structuring the tool mat 10 so as to substantially cover the top step T with the closely spaced magnetic bars 16 positioned immediately beneath the obverse panel 12, the utility and versatility of the stepladder L is greatly enhanced.

To secure the tool mat 10 atop the top step T, one or a plurality of elongated attaching straps 22 are connected to and extend lengthwise from one end margin of the tool mat 10. Each attaching strap 22 has one surface 24 (or attaching surface) that contains one part of a conventional two-part hook and loop releasable attaching arrangement (e.g., VELCRO®). A mating portion 26 (or mating surface) of the hook and loop arrangement is attached adjacent the opposite end portion of the tool mat 10. When positioned around the top step T, the one surface 24 of each of the attaching straps 22 will releasably engage against the mating portion 26 to secure the tool mat 10 in the position shown in FIGS. 5 and 6.

Referring particularly to FIG. 4, by the material selection of the obverse and reverse panels 12 and 14, the spacing of the holding portions or pockets formed between the seam lines 18a and 18b and more generally at 18, and by arranging the generally rectangular cross section magnet bars 16 with alternately facing polarities S and N, pairs of magnet bars 16 immediately adjacent one another attract one another when the tool mat 10 is in the unfolded, flat configuration so as to automatically adopt a magnetic bar 16 pair arrangement as shown. Between closely attracted magnetic bar pairs, the thinner obverse panel 12 is drawn therebetween toward the heavier reverse panel 14 so that the seam line 18b is associated with a substantially flat, unbent portion of the reverse panel 14. In opposite but similar fashion the reverse panel 14 is drawn between the magnet bar pairs so that the seam line 18a therebetween is drawn toward the outstretched obverse panel 12. By this arrangement, both enhanced magnetic attraction to magnetically attractable articles positioned against or in close proximity to the obverse panel 12 is achieved while enhanced stability of the entire tool mat 10 from inadvertently folding is also achieved. Moreover, the magnet bar 16 pairs are more strongly resistant to breakage of the delicate sintered ferrite magnetic bars 16. Additionally, while the magnetic bars 16 have been described as being arranged with polarities in a particular orientation, it will be appreciated that the magnets may be arranged in other polarities (including any arrangements described below) that are suitable to the user.

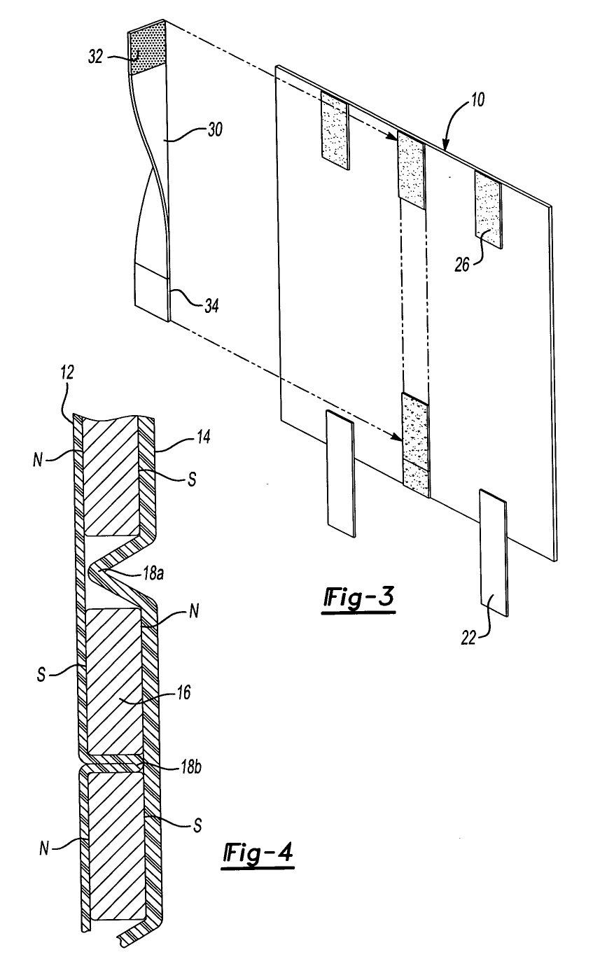

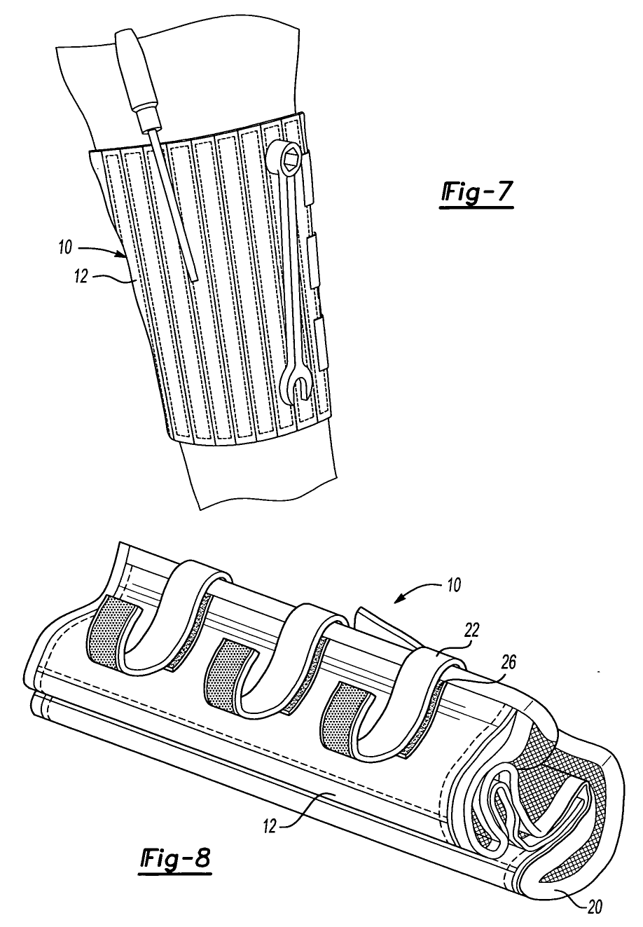

Referring now to FIGS. 3 and 7, the tool mat 10, through the utilization of an auxiliary strap 30, shown stored in phantom in FIG. 3, may be effectively elongated and attached around the thigh or upper leg of a user. The perimeter of the thigh is typically substantially greater than the transverse circumference around the top step T of the ladder L shown in FIGS. 5 and 6 and this extra length is provided by the auxiliary strap.

To deploy the tool mat 10 around the user's thigh, the auxiliary strap 30 is attached to one of the attaching straps 22 by mating two-part attaching material 34 and the other end portion 32 of the opposite surface of the auxiliary strap 30 is attached to the corresponding mating surface 26 to secure the device 10 in the position shown in FIG. 7 for use.

Referring lastly to FIG. 8, the tool mat 10 is easily storable into a configuration there shown by simply starting the folding movement of two or more of the magnetic bars 16 together whereupon the entire tool mat 10 will self-collapse into the position shown in FIG. 8 wherein the obverse surface 12 is exposed so that the attaching straps 22 will be positioned in alignment with the corresponding mating two part attaching portions 26 as shown.

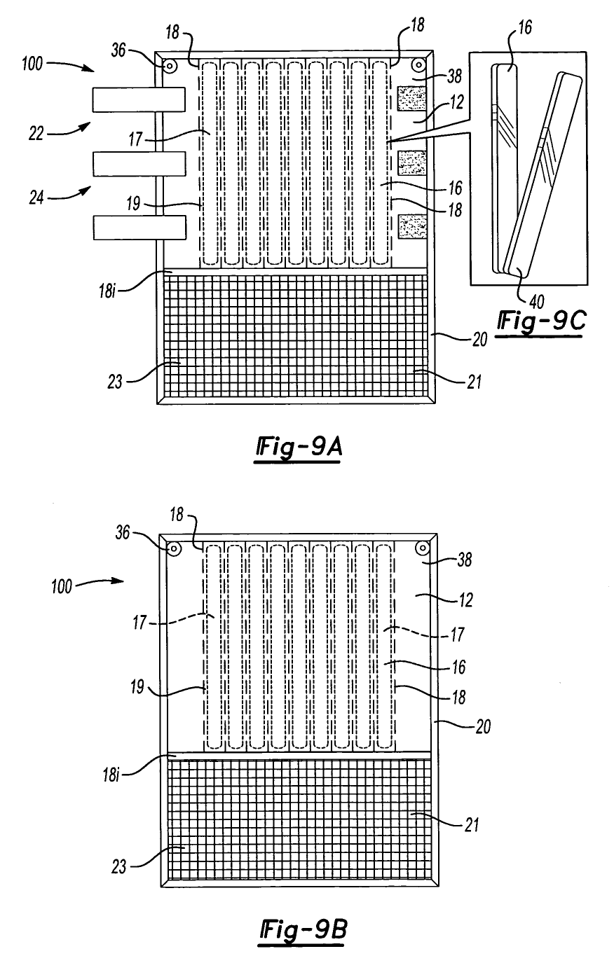

Referring now to FIGS. 9A-C, there is shown a first alternative embodiment of the tool mat 100 of the present invention. The tool mat 100 is generally constructed, as provided above, to include an obverse panel 12 (formed from a relatively thinner flexible elastic fabric material) and a reverse panel 14 (formed from a substantially heavier flexible material). The panels 12, 14 are connected along common side and end margins and finished in appearance with binding material 20. The panels are also connected by seam lines 18 that are spaced apart in a parallel fashion to one to another and the end margins so as to define a plurality of closely spaced side by side elongated magnetic bar holding portions 19. A pocket 21 is formed by sewing (or otherwise securing) a pocket panel 23 (also formed from a relatively thinner flexible elastic fabric material) to the obverse panel 12. Alternatively, the pocket 21 may be formed by cutting a pocket opening in the obverse panel 12 below an intermediate seam line 18i such that the pocket 21 is formed by the interior space between the obverse panel 12 and the reverse panel 14.

As best shown in FIG. 9A, the tool mat 100 may also include attaching straps 22. Each attaching strap 22 having one surface 24 (or attaching surface) that contains one part of a conventional two-part hook and loop releasable attaching arrangement (e.g., VELCRO®). A mating portion 26 (or mating surface) of the hook and loop arrangement is attached adjacent the opposite end portion of the tool mat 10. Alternatively, as shown in FIG. 9B, the tool mat can be constructed without attaching straps 22. A pair of grommets 36 are positioned in opposing corners at one end 38 of the tool mat 100 to assist a user in hanging or otherwise suspending the tool mat 100 from a support (not shown).

An elongated magnetic bar 16 is positioned and secured within each of the holding portions 19. It will be appreciated that, during manufacture of the tool mat 100, each magnetic bar 16 may first be glued, bonded or otherwise secured to one of the panels 12, 14. Thereafter, the panel 12, 14 having the magnetic bars 16 may be overlaid with the other panel 12, 14 and the whole sewn together as described. The magnetic bars 16 are formed of highly magnetic material such as sintered ferrite C8 or anisotropic boded ferrite for added toughness and are well known in the industry for high magnetic strength. Alternatively, the magnetic bars 16 may be a ceramic or rare earth magnetic. The ends and/or edges of the magnetic bars 16 are preferably rounded to inhibit the bars 16 from piercing either of the panels 12, 14 during use.

The magnetic bars 16 are preferably arranged such that the end (or outlying) magnets 17 have alternately facing polarities S and N from the adjacent interior bar 16. Preferably, the end magnets 17 are arranged to have a magnetic attraction toward the reverse panel 14 such that the tool mat 100 may be secured to an object (such as a tool box, not shown). Additionally, the bars 16 may be arranged in any manner discussed in my U.S. Pat. No. 6,530,508, issued Mar. 11, 2003, which is incorporated herein by reference in its entirety, or my co-pending U.S. patent application Ser. No. 10/______, filed Mar. 10, 2003, entitled Utility Wristband, which is a continuation-in-part of Ser. No. 09/954,493, which is incorporated herein by reference in its entirety.

As best shown in FIG. 9C, where ceramic magnets are used as the magnetic bars 16, a web 40 is secured (or otherwise bonded) to one side of each bar 16. Preferably, the web 40, which may be a fabric such as nylon or vinyl or a metal such as steel strip, is glued, bonded or otherwise secured to one side of each magnetic bar 16 as a means of preventing or diminishing damage to the magnetic bar 16. Specifically, the web 40 may be used to cushion the magnetic bars 20 from damage. Additionally, the web 40 serves to retain the shape/form of the magnetic bars 16 in the event the bars 16 are cracked or shattered.

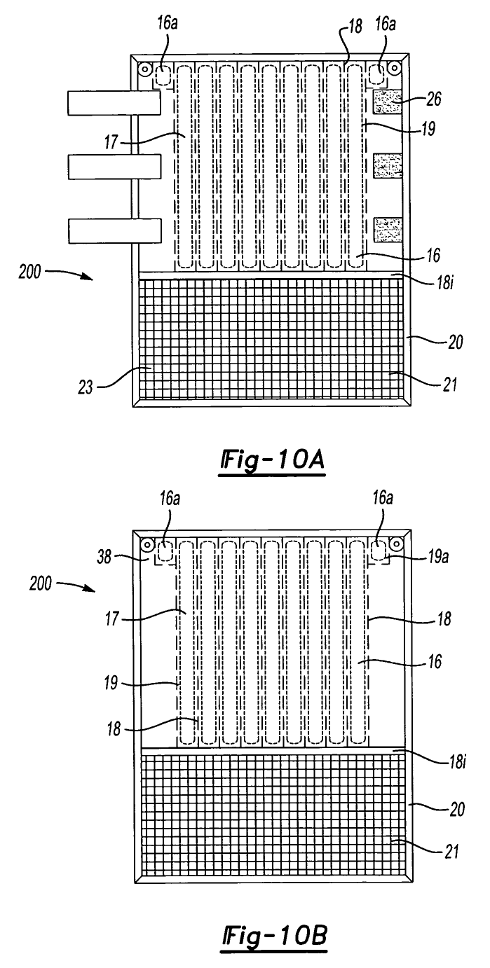

Referring now to FIGS. 10A-B, there is shown a second alternative embodiment of the tool mat 200 of the present invention. The tool mat 200 is generally constructed, as provided above, to include an obverse panel 12 and a reverse panel 14. The panels 12, 14 are connected along common side and end margins and finished in appearance with binding material 20. The panels 12, 14 are also connected by seam lines 18 that are spaced apart in a parallel fashion to one to another and the end margins so as to define a plurality of closely spaced side by side elongated magnetic bar 16 holding portions 19. Additionally, satellite holding portions 19a are formed in opposing corners at one end 38 of the tool mat 100. A pair of grommets 36 are positioned proximate the satellite holding portions 19a.

A pocket 21 is formed by sewing (or otherwise securing) a pocket panel 23 to the obverse panel 12. Alternatively, the pocket 21 may be formed by cutting a pocket opening in the obverse panel 12 below an intermediate seam line 18i such that the pocket is formed by the space between the obverse panel 12 and the reverse panel 14.

As shown in FIG. 10A, the tool mat 200 may also include attaching straps 22. Alternatively, as shown in FIG. 9B, the tool mat 200 can be constructed without attaching straps 22.

An elongated magnetic bar 16 is positioned and secured within each of the holding portions 19. Additionally, a pair of mounting magnets 16a is positioned in each of the satellite holding portions 19a. The mounting magnets 16a are preferably arranged to provide a magnet attraction toward the reverse panel 14 so as to provide the tool mat 200 with additional magnetic adhesion force for use in securing the tool mat 200 to a metallic object such as a toolbox. The magnetic bars 16 and mounting magnets 16a may also be arranged in any manner described above.

It will be appreciated that, during manufacture of the tool mat 200, each magnetic bar 16 and each mounting magnet 16a may first be glued, bonded or otherwise secured to one of the panels 12, 14. Thereafter, the panel 12, 14 with the magnetic bars 16 and each mounting magnet 16a may be overlaid with the other panel and the whole sewn together as described. The magnetic bars 16 and each mounting magnet 16a are formed of highly magnetic material such as sintered ferrite C8 or anisotropic boded ferrite for added toughness and are well known in the industry for high magnetic strength. Alternatively, the magnetic bars 16 and each mounting magnet 16a may be a ceramic or rare earth magnetic material.

Referring now to FIG. 11, there is shown a third alternative embodiment of the tool mat 300 of the present invention. The tool mat 300 is constructed as provided and includes an obverse panel 12 and a reverse panel 14. The panels 12, 14 are connected along common side and end margins and finished with binding material 20. The panels are also connected by seam lines 18 that define a plurality of closely spaced side by side elongated magnetic bar holding portions 19. The holding portions 19 of the third alternative embodiment of the tool mat 300 are arranged in two rows of nine columns. This arrangement neatly divides the whole of the tool mat 300 into 3 substantially equal sections and provides a user with greater flexibility in arranging the position and polarity orientations of the various magnetic bars 16. Therefore, it will be appreciated that the tool mat of the present invention may be constructed in a variety of forms to fit the needs of the user.

Still referring to FIG. 11, a pocket 21 is formed by sewing or otherwise securing a pocket panel 23 (also formed from a relatively thinner flexible elastic fabric material) to the obverse panel 12. The tool mat 300 may also be constructed with or without attaching straps 22. A pair of grommets 36 are positioned in opposing corners at one end 38 of the tool mat 300 to assist a user in hanging or otherwise suspending the tool mat 300 from a support (not shown).

An elongated magnetic bar 16 is positioned and secured within each of the holding portions 19. The magnet bars 16 may also be arranged in any manner described above. It will be appreciated that, during manufacture of the tool mat 300, each magnetic bar 16 may first be glued, bonded or otherwise secured to one of the panels 12, 14. Thereafter, the panel 12, 14 with the magnetic bars 16 may be overlaid with the other panel and the whole sewn together as described.

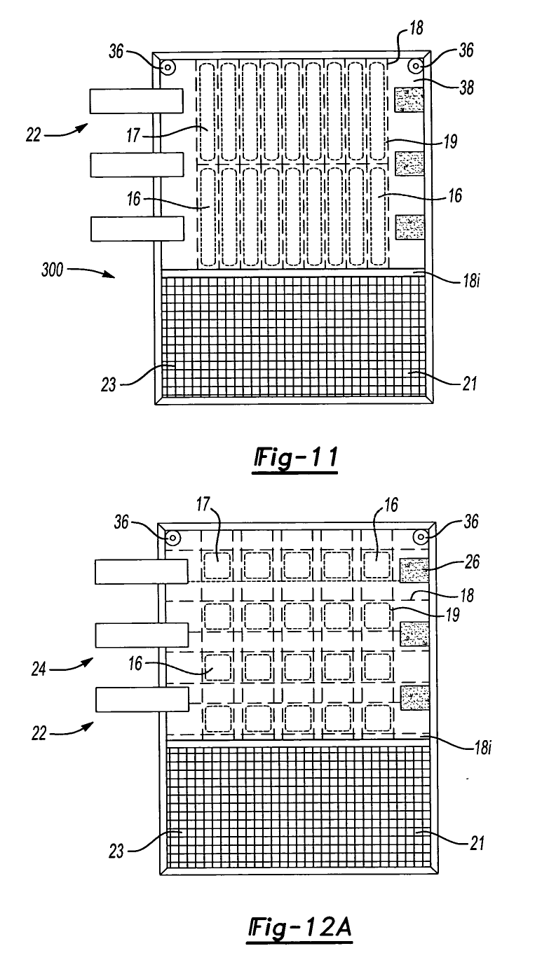

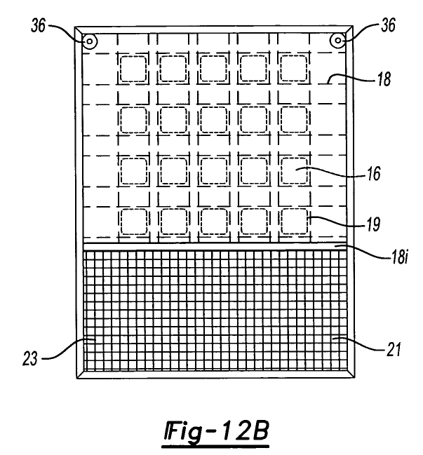

Referring now to FIGS. 12A-B, there is shown a fourth alternative embodiment of the tool mat 400 of the present invention. The tool mat 400 is constructed as provided and includes an obverse panel 12 and a reverse panel 14. The panels 12, 14 are connected along common side and end margins and finished with binding material 20. The panels are also connected by seam lines 18 that define a plurality of closely spaced side by side elongated magnetic bar holding portions 19. The holding portions 19 of the fourth alternative embodiment of the tool mat 400 are arranged in four rows of five columns. A pocket 21 is formed by sewing or otherwise securing a pocket panel 23 to the obverse panel 12. The tool mat 400 may also be constructed with (FIG. 12A) or without (FIG. 12B) attaching straps 22. A pair of grommets 36 are positioned in opposing corners at one end 38 of the tool mat 400 to assist a user in hanging or otherwise suspending the tool mat 400 from a support (not shown).

A magnetic bar 16 is positioned and secured within each of the holding portions 19. Specifically, in this embodiment the magnetic bars 16 are preferably formed by 20 evenly spaced one-inch square magnets. The magnetic bars 16 may also be arranged in any manner described above. It will be appreciated that, during manufacture of the tool mat 400, each magnetic bar 16 may first be glued, bonded or otherwise secured to one of the panels 12, 14. Thereafter, the panel 12, 14 with the magnetic bars 16 may be overlaid with the other panel and the whole sewn together as described.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A tool mat comprising:
an obverse panel and a reverse panel, said obverse and reverse panels being secured together to form a plurality of magnet holding portions;
a plurality of magnets, each magnet of said plurality of magnets being positioned within a magnet holding portion.

2. The tool mat of claim 1 further comprising a pocket panel secured to said obverse panel.

3. The tool mat of claim 1 further comprising an elongated attaching strap secured to one of said obverse or reverse panels.

4. The tool mat of claim 3, wherein one surface of a two part attaching arrangement is disposed on said attaching strap and a mating portion of said attaching arrangement is disposed on said obverse panel.

5. The tool mat of claim 1 further comprising a pair of grommets positioned in opposing corners at one end of the mat.

6. The tool mat of claim 1 further comprising a web secured to one side of said magnet of said plurality of magnets.

7. The tool mat of claim 6 wherein said web comprises a steel strip.

8. The tool mat of claim 6 wherein said web comprises a nylon web.

9. The tool mat of claim 1, wherein each magnet of said plurality of magnets is secured to one of said obverse or reverse panels.

10. The tool mat of claim 1 further comprising a satellite holding portion formed in opposing corners at one end of the tool mat, said satellite holding portions having a magnet positioned therein.

11. The tool mat of claim 1 wherein an outlying magnet of said plurality of magnets has an alternate facing polarity from an adjacent interior magnet.

12. The tool mat of claim 1 wherein said each magnet of said plurality of magnets is arranged with alternately facing polarities S and N such that pairs of magnets immediately adjacent one another attract one another when the tool mat is in an unfolded, flat configuration.

13. A tool mat comprising:
an obverse panel and a reverse panel, said obverse and reverse panels being secured together to form a plurality of magnet holding portions;
a plurality of magnets, each magnet of said plurality of magnets being positioned within a magnet holding portion;
a pocket panel secured to said obverse panel; and
an attaching strap secured to one of said obverse or reverse panels, said attaching strap having one surface of a two part attaching arrangement and a mating portion of said attaching arrangement being disposed on said obverse panel.

14. The tool mat of claim 13 further comprising a pair of grommets positioned in opposing corners at one end of the mat.

15. The tool mat of claim 13 further comprising a web secured to one side of said magnet of said plurality of magnets.

16. The tool mat of claim 15 wherein said web comprises a steel strip.

17. The tool mat of claim 15 wherein said web comprises a nylon web.

18. The tool mat of claim 13, wherein each magnet of said plurality of magnets is secured to one of said obverse or reverse panels.

19. The tool mat of claim 13 further comprising a satellite holding portion formed in opposing corners at one end of the tool mat, said satellite holding portions having a mounting magnet positioned therein.

20. The tool mat of claim 13 wherein an outlying magnet of said plurality of magnets has an alternate facing polarity from an adjacent interior magnet.
